(19) United States
(12) Patent Application Publication
(10) Pub. No.: US 2019/0335164 A1
(43) Pub. Date: Oct. 31, 2019

(54) DISPLAY SYSTEM AND METHOD

(71) Applicant: PHILIPS LIGHTING HOLDING B.V., EINDHOVEN (NL)

(72) Inventors: DIRK ENGELEN, HEUSDEN-ZOLDER (BE); JOCHEN RENAAT VAN GHELUWE, LOMMEL (BE); PHILIP STEVEN NEWTON, WAALRE (NL); DZMITRY VIKTOROVICH ALIAKSEYEU, EINDHOVEN (NL)

(21) Appl. No.: 16/309,479

(22) PCT Filed: Jun. 7, 2017
(86) PCT No.: PCT/EP2017/063835

§ 371 Date: Dec. 13, 2018

(30) Foreign Application Priority Data
Jun. 21, 2016 (EP) 16175389.2

(51) Int. Cl. H04N 13/302; H04N 21/41; H04N 21/414; H04N 21/431; H04N 21/442; H04N 21/4722

(52) U.S. Cl. CPC H04N 13/302; H04N 21/4122; H04N 21/41415; H04N 2013/40; H04N 21/44218; H04N 21/4722; H04N 21/431

(57) ABSTRACT

The invention provides a display system which incorporates two display devices. A first is larger than a second, but with a lower resolution. The higher resolution second display is a directional display and it has its output area within the overall output area of the first display. This system integrates a general display for long range viewing by multiple people with a short range higher resolution display for interaction with one or a small number of users.

### FIELD OF THE INVENTION

This invention relates to display systems, in particular including displays for providing general content to large numbers of viewers at a relatively far distance, and also more specific information to one or a small number of viewers at a relatively near distance.

### BACKGROUND OF THE INVENTION

It is known to use luminous panels to provide a low resolution display output for viewing by multiple viewers at a large distance. They can be used for the creation of light atmospheres and to set lighting conditions. With these panels, low resolution dynamic content can also be rendered, even in an interactive way.

In public spaces, these displays can also be used for information broadcast. In most cases, this is done on large information displays, visible for everybody or via smaller personal (interactive) displays. Examples of such information displays can be found in airports, where large displays announce the arrivals and departures of the planes. Smaller interactive displays are used for automatic check-in or for providing general information to users.

The presence of the large low resolution display and smaller high resolution displays in public environments causes a visual clutter of the environment.

There is therefore a need for a solution to the provision of general crowd information as well as specific user information in a way which does not clutter a space and does not detract from the aesthetic design of the space.

Patent application WO 2007/007862 A1 discloses an interactive multiple view display system has a multiple view display which displays images of independently selectable content so as to make them visible to different viewers in respective different viewing regions. A detection arrangement detects which of a plurality of users is attempting to interact with one of the displayed images. An interaction arrangement then permits the detected user to interact with the image.

Patent application WO 2015/031802 A1 discloses a video display system that includes a computerized media processing unit configured to receive content including video, audio, graphics and internet content from a plurality of content source devices providing such content and configured to output a blended video signal receivable by a display device; and wherein the video signal output by the media processing unit comprises a plurality of arbitrarily shaped video containers all displayable on the display device simultaneously, each of the plurality of video containers capable of being positioned and displaying video content independent of the video content of the other video containers; wherein the video content displayed in one container may comprise a GUI for control of size and position of each of the other of the plurality of video containers in response to user commands

### SUMMARY OF THE INVENTION

The invention is defined by the claims.

According to examples in accordance with an aspect of the invention, there is provided a display system comprising:

a first display device having a first display output area, adapted to display a first image with a first display resolution and a first lateral range of output directions;

a second display device having a second display output area and a second display resolution higher than the first display resolution, wherein the second display output area is smaller than the first display output area and is positioned within the outer limit of the first display output area and thus fills a window in the first display output area;

wherein the second display device is adapted to display a second image with the second display resolution in a second lateral range of output directions which is narrower than the first lateral range of output directions.

This system combines two display devices. The first provides low resolution wide angle content. This is for example a large image for viewing by large numbers of people from a distance. It may provide general information, for example flight arrival or departure information on a large airport display screen. The second provides high resolution narrow angle content. This is for interaction with a single viewer or a small group of viewers who are close up to the display. They may be performing tasks such as checking-in or obtaining more specific information. The second display device does not detract from the overall appearance of the first display device because it has a narrow range of output angles for its high resolution directional content. The location in front of the second display device may be considered to be an experience spot. By providing the second display device within the overall display area of the first display device, the overall general appearance is preserved, and it is avoided that the area becomes cluttered with multiple screens.

The overall picture provided by the first display device can be perceived from almost all locations of the environment. The high resolution information is only rendered towards the experience spot.

The second display device is for example adapted to display a third image which is different to the second image in a third lateral range of output directions (but excluding the second range of output directions) which is wider than the second lateral range of output directions.

This third image may replicate the missing portion of the first image, and it may be provided with a range of viewing angles corresponding to the first display device. In this way, the second display device is made more invisible to viewers who are outside the experience spot of the second display device. This further enhances the feeling that the space is not cluttered with display screens.

The third lateral range of output directions may be equal to the first lateral range of output directions. This means the second display device generates a similar output to the first display device thus filling the window with the image portion that is missing from the first image. Thus, the first image and the third image may be parts of an overall combined image representing the same scene.

By “scene” is meant an image which has a single design, for conveying the same feeling, mood or set of information across its area, rather than being a patchwork of different images of different designs.

The system may further comprise an output screen which is shared between the first and second display devices. This output screen creates a shared overall visual appearance thus giving the impression of a single screen. The output screen may be a fabric sheet and it may incorporate a diffuser, at least in the first display output area.

In a first example, the first display device may comprise an array of light sources behind the output screen, and the second display device comprises a multi-view display.

Multi-view display device technology is mature, and enables different images to be provide in different directions.

One view of the second display device (e.g. straight ahead) may be provided with the higher second display resolution and the other views simulate the first display resolution. The native display used in the direction display device will be sufficiently high for the higher second display resolution, but the display can be driven to emulate the lower resolution of the missing window of the first image. The multi-view display may use a lens or barrier based approach as is well known to those skilled in the art. Preferably, the multi-view display is a single cone display, so that the main central image is not repeated at other viewing directions in other viewing cones.

In a second example, the first display device may comprise an array of light sources behind the output screen, and the second display device comprises a first array of fibers and collimators for providing relatively narrow directional light to the output screen and a second array of fibers for providing relatively broad directional light to the output screen.

The collimators are used to provide narrow direction light, for example directly in front of the second display device, whereas the second array of fibers are positioned so that they have a spread of output angles.

The first array of fibers may have the same resolution as the second array of fibers, and the image content is generated to emulate the lower resolution at wider viewing angles. Alternatively, the first array of fibers may be arranged with a greater resolution than the second array of fibers. In particular, the second array of fibers are used to emulate the display output from the first display device, whereas the first array of fibers provide the higher resolution direction content to the experience spot.

The system may further comprise a directional audio system for providing audio to a user in front of the second display device. This audio may then be specific to the experience spot rather than for general use.

A presence detection system may be provided, wherein the second display device is adapted to display a second image only when a user is present in front of the second display device.

Examples in accordance with another aspect of the invention provide a display method comprising:

using a first display device to display a first image with a first display resolution and a first lateral range of output directions over a first display output area; and

using a second display device to display a second image with:
a second display resolution higher than the first display resolution;
a second display output area which is smaller than the first display output area and which is positioned within the outer limit of the first display output area and thus fills a window in the first display output area; and
a second lateral range of output directions which is narrower than the first lateral range of output directions.

This makes use of one display device having an output which is located within the output of a larger display device, to provide local higher resolution directional images.

The method for example comprises using the second display device to display a third image which is different to the second image in a third lateral range of output directions which is wider than the second lateral range of output directions, for example equal to the first lateral range of output directions.

The first image and the third image may be parts of an overall combined image representing the same scene. The first and second display device outputs may be provided through a shared output screen.

### BRIEF DESCRIPTION OF THE DRAWINGS

Examples of the invention will now be described in detail with reference to the accompanying drawings, in which:

FIG. 1 shows a display system with different output areas;

FIG. 2 shows an image as viewed other than directly in front of a second display device;

FIG. 3 shows what is seen from directly in front of the second display device;

FIG. 4 shows the viewing angle ranges for the two display devices;

FIG. 5 shows in schematic form a second display device implemented as a fiber display device;

FIG. 6 shows in schematic form a second display device implemented as a multi-view display device;

FIG. 7 shows an example in more detail based on a fiber display as the second display device;

FIG. 8 shows an example in more detail based on a multi-view display as the second display device;

FIG. 9 shows the display system combined with directional audio speakers;

FIG. 10 shows interactivity used to only activate the second display device when someone is detected nearby;

FIG. 11 shows how the system may detect people who are close to the panel but approaching the area of the second display device from the side; and

FIG. 12 shows the overall system components.

### DETAILED DESCRIPTION OF THE EMBODIMENTS

The invention provides a display system which incorporates two display devices. A first is larger than a second, but with a lower resolution. The higher resolution second display is a directional display and it has its output area within the overall output area of the first display. This system integrates a general display for long range viewing by multiple people with a short range higher resolution display for interaction with one or a small number of users and with a degree of privacy.

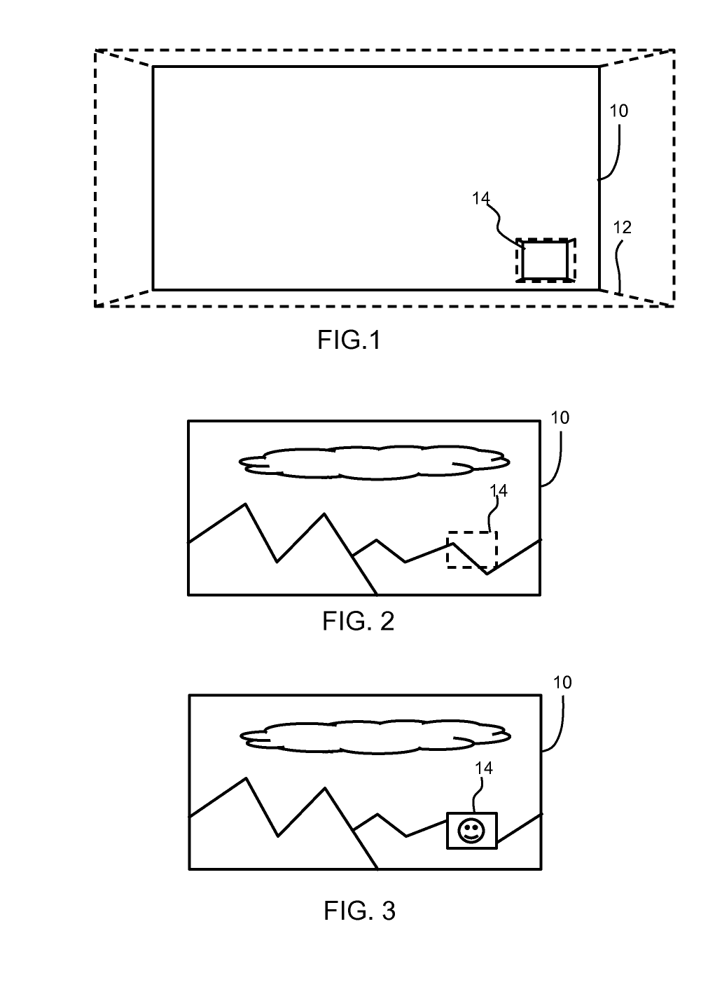

FIG. 1 shows the display system, and in particular different output areas presented by the display system.

It comprises a first display device having a first display output area 10. This output area is used to display a first image with a first display resolution and a first lateral range of output directions 12. It is for general viewing by the public, in particular for multiple viewers at the same time, and generally from a significant distance from the display. Thus, the lateral range of output directions is as large as possible, for example covering more than 100 degrees, and preferably more than 120 degrees. In practice, by providing illumination to a diffusive screen, the range of output directions may in theory cover 180 degrees. It has a relatively low resolution because it is for creating a general lighting atmosphere or for providing information to be read by many people from a large distance.

Typically, the area of the output of first display device is between 0.5 m² and 10 m² although even larger sizes are possible. For example, first display device may have a length between 1 m and 5 m and a height between 0.5 m and 2 m. One example is a length of 1.5 m and a height of 0.5 m. The first display has a wide viewing angle, for example 175 degrees visibility.

The first display device may use an array of light sources such as LEDs to build up a low resolution image using point light sources. It may be a single color or a multicolor display.

By way of specific example, the first display device may be as large as 5 m×2 m, displaying content of a resolution of 400×300 pixels. This gives a pitch of around 2 dpi (dots per inch) equivalent to 0.75 pixels per cm. Even lower pixel densities are however possible, such as a pixel pitch of 60 mm (0.16 pixels per cm). The LED pixels are for example formed as a string of discrete LED pixels mounted on a (flexible) surface. Other configurations and interconnections are possible. Exact viewing of content from all angles is not important for the first display device. Typically, the resolution is less than 5 dpi (2 pixels per cm).

A second display device has a second display output area 14 and a second display resolution higher than the first display resolution. The second display output area 14 is smaller than the first display output area 12 and it is positioned within the outer limit of the first display output area 10. In this way it fills a window in the first display output area 10. Typically, the area of the output of first display device is between 0.05 m² and 0.3 m². For example, first display device may have a length between 0.25 m and 0.7 m and a height between 0.2 m and 0.4 m. One example is a length of 540 mm and a height of 320 mm (comparable to a 60 cm 16:10 display). The second display device for example has a resolution of between 15 and 250 dpi (6 to 100 pixels per cm). Typically, the resolution is greater than 15 dpi (6 pixels per cm).

The second display device has a narrow viewing angle for example of 10 to 25 degrees. The second image is further more concentrated to the sweet spot (the “experience spot”) at which the content of the complete display is visible. The second display device is for example a flat multi-view display, but it may instead have a curved surface.

The second display device is used for displaying a higher resolution image with a narrow directional output. This means that most of the public within the space housing the display system do not see the high resolution output of the second display device. Instead, it is directed more narrowly to a viewer or a small number of viewers who are using the second display device for interaction. In particular, the higher resolution output of the second display device is directed forwards to a viewer standing in front of the second display output area 14. The higher resolution image for example comprises written text and images. There may be a user input device associated with the second display device, such as a touch pad.

For viewers who are not engaging with the second display device, the overall appearance of the first display device is less disrupted, because the distraction of the high resolution image is not seen. Instead, the perception of the first display output area 10 may be of a single display device. Only in front of the second display device is there an experience spot where the second display device output is seen.

The second display device may display a third image which is different to the second (high resolution) image in a third lateral range of output directions which is wider than the second lateral range of output directions. This means the second display device outputs first content to the users of the experience spot, and outputs a different image to other viewers. In particular, the third image provided by the second display device is intended to correspond to the missing part of the first image. This is explained with reference to FIGS. 2 and 3.

FIG. 2 shows an image as viewed other than directly in front of the second display device. A low resolution image is output in the first display output area 10. The second display output area 14 also outputs the relevant (i.e. missing) portion of the same image, so that the general appearance is of a single image. It may comprise an image and/or text and it may be essentially static for setting a mood or scene or it may be dynamic. It may convey information or it may simply set a desired atmosphere in the space.

FIG. 3 shows what is seen from directly in front of the second display device. The second display output area 14 now shows a high resolution image to provide more information to the viewer, or more user-specific information.

FIG. 4 shows the viewing angle ranges. The first display device 40 has a first lateral range 41 of output angles. The second display device 42 has a narrower second lateral range 43 of output angles for displaying the high resolution image 46. This second lateral range 43 of output angles may for example be less than 25 degrees, or even less than 10 degrees.

The second display device also has a third lateral range 48 of output angles for a lower resolution image, in particular to fill in the missing part of the image displayed by the first display device 40 as explained above. This excludes the angle range 43, so that the third lateral range 48 extends between a non-zero minimum angle (e.g. 5 or 10 degrees each the side of the normal) to the maximum angle (i.e. up to 90 degrees each side of the normal).

The third range 48 may be equal to the first range 41 but an exact match is not essential.

In this way, the second display device is made much less noticeable to viewers who are outside the experience spot of the second display device, as seen in FIG. 2.

The invention provides the integration of two display types into a single system. Two possible implementations are discussed below.

In each case, the first display device 40 is a luminous panel comprising an array of light sources 50 which illuminate the output area through a diffusive screen 52. This diffusive screen for example is a fabric screen.

The fabric is illuminated, and the illuminated pattern may then be visible across a full 180 degree viewing angle (subject of course to the issue that the perceived width of the screen decreases at increasing lateral viewing angles).

The luminous panel of the first display device 40 renders the low resolution lighting content on the complete panel. This content may be static or dynamic. Typical examples are moving clouds, water effects, nature effects. These effects are rendered on the fabric outer surface of the luminous panel.

FIG. 5 shows in schematic form a second display device 42 implemented as a fiber optical image transfer device. The visible outer surface of the screen 52 is not changed so that the system has the appearance of a single entity. Fiber paths deliver the pixelated image of the second display device 42 in a directional way to the viewer 54.

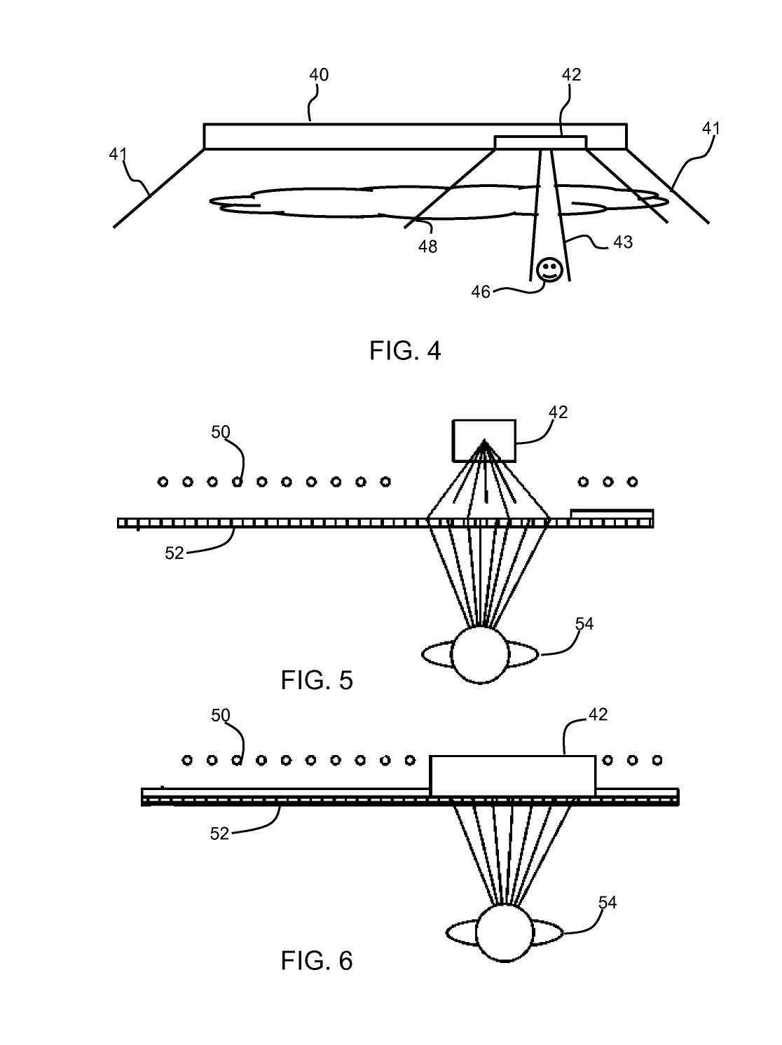

FIG. 6 shows in schematic form a second display device 42 implemented as a multi-view display device. A light field display may also be used.

FIGS. 5 and 6 show that the outer (viewer side) surface of the output screen 52 covers the full area 10 and is thus shared by the first and second display devices. This creates a shared overall visual appearance thus giving the impression of a single screen.

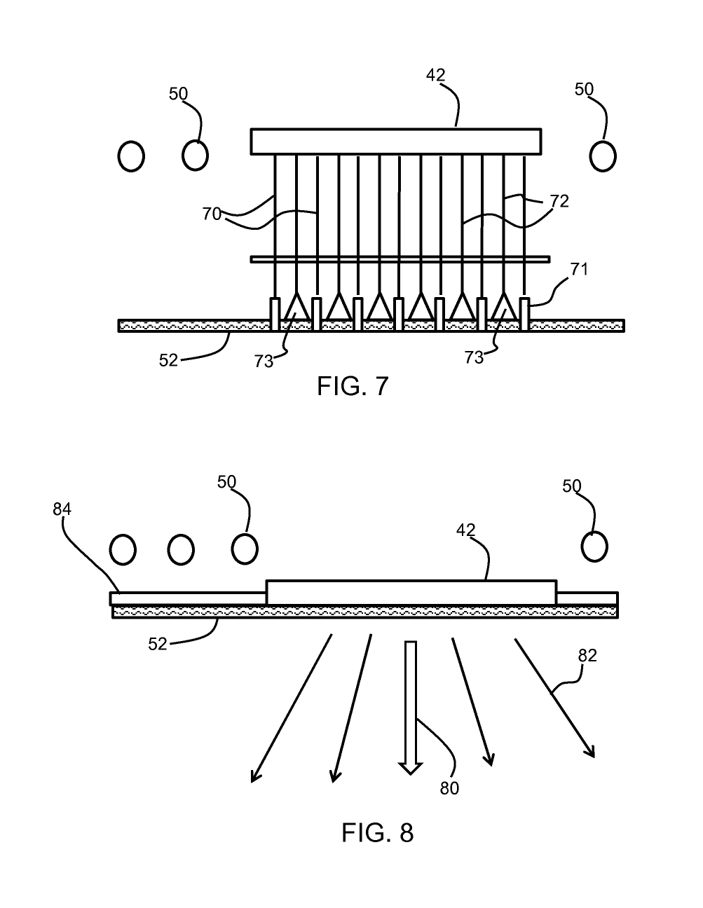

FIG. 7 shows one possible implementation of a fiber display 42 in more detail. The display comprises a pixelated display panel, and an array of optical fibers. The display panel for example comprises a liquid crystal display panel. The optical fiber array comprises a first set of fibers 70 and a second set of fibers 72. The fibers all start at the output surface of the display panel and they route the light from a respective portion of the displayed image. The fibers may each correspond to a single pixel of the native display panel, or each fiber may be associated with an area of the display device corresponding to a sub-array pixels.

A pixel pitch of 40 dpi (16 pixels per cm) is an example. This resolution may be achieved with 0.25 mm diameter fibers and these fibers may be woven into a structure. Light projection is used to illuminate the fibers. Theoretically, up to 100 dpi is possible.

The fibers 70 each terminate with a collimator 71 that is attached to the fabric screen and directs light to the experience spot.

It is desired that the diffusion function of the screen is not used. Thus, the collimators may terminate directly beneath a non-diffusive surface layer of the screen 52, so that the diffusive function of the screen (for spreading the light of the light sources 50) is not used.

These fibers 70 form the high resolution rendering part of the system.

The fibers 72 terminate behind the screen 52 without output collimators. Their light output is shown as 73. It illuminates the screen in the same way as the light sources 50. The pitch between the fibers 72 may be much smaller than the pitch between the light sources 50 so that a high resolution content could be rendered. However, by suitably driving the display panel with low resolution image content, a low resolution output is generated which matches the output display of the first display device, namely the luminous panel.

The fiber array may be a regular array of fibers, with the same fiber pitch for the first and second fibers 70, 72. However, it is also possible for the first fibers 70 to be arranged with a greater resolution than the second fibers 72. In this case, the achievable resolution is lower outside the central viewing direction.

Mechanical stability is provided by the attachment of collimators 71 and fibers to the output screen, and a fixing plate may also be used to keep the internal fibers in position.

Note that the display 42 can be smaller than the surface on the screen to which the image is provided. Thus, an expanding array of fibers may be employed to expand the effective size of the native display.

FIG. 8 shows an example in more detail based on a multi-view display as the second display panel.

Multi-view display panels are well known. This design provides a much simpler implementation, and it also enables the second display device to implement an autostereoscopic display if desired. This is therefore a preferred implementation.

Multi-view display devices output different views or images in different directions. They are used in privacy displays and in autostereoscopic displays. By way of example, a standard display panel is provided with a view forming arrangement, such as an array of lenticular lenses, for directing different views in different directions.

Multi-view display panels may provide their different views simultaneously or time-sequentially, for example using a switchable barrier. A parallax barrier multi-view display is for example suitable.

FIG. 8 shows that the principal forward view 80 is rendered with high resolution content, while the other views 82 are used to simulate the rendering of the low resolution image of the first display device (the luminous panel).

A design is preferred with a single cone of output images, so that there is no repetition of different images. Thus, the central image is provided only in the central direction and is not repeated at other viewing angles.

As in the example of FIG. 7, the second display device may be capable of generating high resolution content in all viewing directions, but the display may be driven with low resolution image content so that a low resolution output is generated which matches the output display of the first display device, namely the luminous panel.

The display output 80 in the forward direction may be an autostereoscopic image.

FIG. 8 also shows that the screen 52 includes a diffuser 84 for masking the lighting of the low resolution matrix of light sources 50. The diffuser 84 is not present in front of the multi-view display 42.

The screen fabric 52 is used to hide the different display infrastructures so that the diffuser 84 and display 42 cannot be distinguished easily visually. However, it is sufficiently transparent to avoid the obstruction of the light in the direction of the central view. A fabric that acts as a barrier (and thereby provide a diffusion function) in all directions except the orthogonal direction may be used for this purpose.

The multi-view display 42 may provide only two images. One image is the image or video content to be directed towards the experience spot. The other image is for all other views, and is the ambient view corresponding to the image of the first display device.

The system may also include a directional audio system. Various directional audio systems are known. Possible approaches include the use of ultrasound, speaker arrays with phase shifted audio, and electrostatic speakers. The directional audio output is then directed to the experience spot.

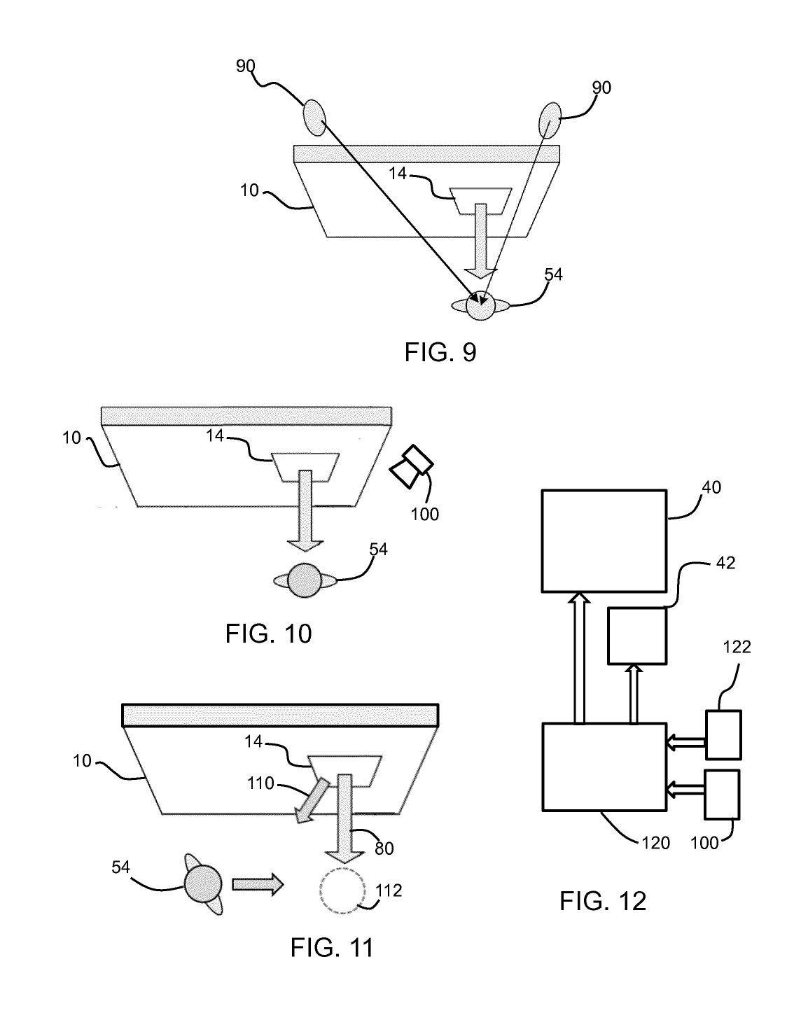

FIG. 9 shows the display system combined with directional audio speakers 90. They provide directed sound to the experience spot.

The system may also be interactive. As shown in FIG. 10, for this purpose a presence detection system 100 such as a camera and image processing system may be used for detecting when a user is present in front of the second display device.

As illustrated in FIG. 10, the interactivity can be used to only activate the experience spot when someone is detected nearby. If no viewer is detected, even the forward view is provided with the low resolution image to blend with the image provided by the first display device. Thus, when viewed from a sufficient distance the image from the second display device becomes indistinguishable from the low resolution content of the rest of the screen.

The system may also detect the people who are close to the panel but approaching the area of the second display device from the side. This is shown in FIG. 11.

The second display device (when implemented as a multi-view display) may then direct a (distorted) side view 110 to the viewer indicate to the user that he or she is approaching an embedded information display and should therefore advance to the experience spot 112.

FIG. 12 shows the overall system, comprises the first and second display devices 40, 42 and a controller 120 for controlling the driving of the two displays. A user input interface 122 enables the second display in particular to display interactive content, and the presence detection system 100 is also shown for automated control of the image content, again in particular of the second display device 42.

The invention is of interest for public spaces in which a high resolution rendering of video or other content is needed for local consumption by a user. Outside this experience spot, the infrastructure is hidden and the high resolution content is not visible.

One example application is check-in terminals hidden within a larger panel, or information displays that provide personal information. It enables different information to be provided to viewers in different locations. The second display device may be for interactive use or it may simply provide information content which depends on the position and not on any specific input from a user.

It is explained above that the range of lateral viewing angles for the high resolution image is reduced. There may also be a restriction to the viewing angles in the up-down direction for example so that the high resolution content is not available from higher (e.g. when standing on a gallery) overlooking the display. This may be used to increase the privacy.

The input from the user for interacting with the second display device may include speech recognition or gesture recognition as well or instead of touch input as mentioned above.

The controller will comprise standard display drivers for the two display devices, with synchronized content, so that the wide views of the second display device complement the display data of the first display device.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A display system comprising:
a first display device having a first display output area, adapted to display a first image with a first display resolution and a first lateral range of output directions;
a second display device having a second display output area and a second display resolution higher than the first display resolution, wherein the second display output area is smaller than the first display output area and is positioned within the outer limit of the first display output area and thus fills a window in the first display output area;
wherein the second display device is adapted to display a second image with the second display resolution in a second lateral range of output directions which is narrower than the first lateral range of output directions,
wherein the second display device is adapted to display a third image which is different to the second image in a third lateral range of output directions which is wider than the second lateral range of output directions, but excluding the second lateral range of output directions, wherein the third lateral range of output directions is equal to the first lateral range of output directions.

2. (canceled)

3. The system as claimed in claim 1, wherein the first image and the third image are parts of an overall combined image representing the same scene.

4. The system as claimed in claim 1, further comprising an output screen which is shared between the first and second display devices.

5. The system as claimed in claim 4, wherein the first display device comprises an array of light sources behind the output screen, and the second display device comprises a multi-view display.

6. The system as claimed in claim 1, wherein one view of the second display device is provided with the second display resolution and the other views simulate the first display resolution.

7. The system as claimed in claim 4, wherein the first display device comprises an array of light sources behind the output screen, and the second display device comprises a first array of fibers and collimators for providing relatively narrow directional light to the output screen and a second array of fibers for providing relatively broad directional light to the output screen.

8. The system as claimed in claim 7, wherein the first array of fibers are arranged with a greater resolution than the second array of fibers.

9. The system as claimed in claim 1, further comprising a directional audio system for providing audio to a user in front of the second display device.

10. The system as claimed in claim 1, further comprising a presence detection system, wherein the second display device is adapted to display a second image only when a user is present in front of the second display device.

11. A display method comprising:
using a first display device to display a first image with a first display resolution and a first lateral range of output directions over a first display output area; and
using a second display device to display a second image with:
a second display resolution higher than the first display resolution;
a second display output area which is smaller than the first display output area and which is positioned within the outer limit of the first display output area and thus fills a window in the first display output area; and
a second lateral range of output directions which is narrower than the first lateral range of output directions, and
using the second display device to display a third image which is different to the second image in a third lateral range of output directions which is wider than the second lateral range of output directions, but excluding the second lateral range of output directions, wherein the third lateral range of output directions is equal to the first lateral range of output directions.

12. The method as claimed in claim 11, wherein the first image and the third image are parts of an overall combined image representing the same scene.

13. The method as claimed in claim 11 comprising providing the first and second display device outputs through a shared output screen.
